(19) United States
(12) Patent Application Publication
(10) Pub. No.: US 2013/0059114 A1
(43) Pub. Date: Mar. 7, 2013

(54) FUSIBLE INTERLINING

(71) Applicants: Peter Grynaeus, Birkenau (DE); Hans Rettig, Laudenbach (DE); Ulrich Scherbel, Munich (DE); Elke Teschner, Weinheim (DE)

(72) Inventors: Peter Grynaeus, Birkenau (DE); Hans Rettig, Laudenbach (DE); Ulrich Scherbel, Munich (DE); Elke Teschner, Weinheim (DE)

(73) Assignee: CARL FREUDENBERG KG, Weinheim (DE)

(21) Appl. No.: 13/594,894

(22) Filed: Aug. 27, 2012

(30) Foreign Application Priority Data
Sep. 2, 2011 (DE) 10 2011 112 098.3
Sep. 5, 2011 (DE) 10 2011 112 267.6

(51) Int. Cl. B32B 3/24

(52) U.S. Cl. 428/137

(57) ABSTRACT

A fusible interlining usable as a front fusible interlining in the textile industry includes a support layer including a weakly bonded and water jet-structured fiber web or nonwoven. The support layer is bonded in preselected areas by a binder and has an adhesive compound on at least one side. The support layer has a grid-like hole structure.

### CROSS-REFERENCE TO PRIOR APPLICATIONS

Priority is claimed to German Patent Application Nos. DE 10 2011 112 098.3, filed on Sep. 2, 2011, and DE 10 2011 112 267.6, filed on Sep. 5, 2011, The entire disclosure of each these applications is hereby incorporated by reference herein.

### FIELD

The invention relates to a fusible interlining, especially one that can be used as a front fusible interlining in the textile industry.

### BACKGROUND

Fusible interlinings are the invisible framework of garments. They ensure the correct fit and optimal wearing comfort. Depending on their use, they contribute to the workability, increase the functionality and stabilize the garment.

Front fusible interlinings serve to reinforce the front part of garments over the entire surface. They consist of a support layer and an adhesive compound coating containing melt adhesives that has been applied to the support layer. During the course of the manufacture of garments, the coated side is laminated onto the front section of the garment in order to stabilize the front section of the garment and to ensure its dimensional stability.

The requirements made of front fusible interlinings are very far-reaching and demanding in the realm of menswear, especially for suits and sports jackets. This applies particularly to the support layer of the fusible interlining itself, which has to meet a wide range of requirements.

The essential requirements made of the support layer are: pleasant textile feel, excellent reinforcing properties to provide dimensional stability, a high volume with a low weight, and high elasticity, especially in the weft direction. A pleasant textile feel is a fundamental prerequisite for incorporation into a high-quality garment.

Good reinforcement properties of the fusible interlining are particularly important in menswear since these are often formal garments such as suits. Particularly in the case of men's clothing in large sizes, there has to be sufficient stiffness and dimensional stability to ensure the correct appearance of the garment.

A high volume of the fusible interlining is very important especially in men's garments since the inner construction of a suit can consist of up to 30 individual pieces, and the individual components of the construction must not show through the outer fabric on the outside of the garment. Therefore, the fusible interlining has to have a high volume in order to reliably prevent these impressions from showing through on the outside,

Modern outer fabrics are elastic in at least one direction and often even hi-elastic. This makes them very comfortable to wear and allows the garment to be tailored to be form-fitting. High elasticity of the fusible interlining makes it possible for the fusible interlining to adapt universally to as many types of outer fabrics as possible.

Since the outer fabrics themselves are becoming lighter and lighter, a low weight of the fusible interlining has acquired tremendous importance. Moreover, a low weight also means less material consumption and thus lower costs for the fusible interlining.

Nowadays, the front fusible interlinings of men's garments make use almost exclusively of woven or knit fabrics as the support material. These wovens and knits consist primarily or exclusively of textured polyester filaments that are arranged in warp and weft yams. These wovens and knits offer good reinforcement properties, high volume and good elasticity due to the crimping of the textured yarns and the corresponding weave structure. These support layers are coated with the adhesive compound coating by means of the conventional coating methods, but especially with double-dot coating methods such as the dot-dripping method.

The weight of the wovens and knits is generally between 50 g/m² and 100 g/m². As far as their hand is concerned, these products are well-accepted on the market. However, since the filaments are textured, there are no fiber ends on the surface of the fusible interlining that could create a soft and textile hand, so that the hand impression of these wovens and knits tends to be dull and synthetic because of their structure.

A number of attempts have been made to eliminate these disadvantages in terms of the hand as described, for instance, in German patents DE 196 44 111 or DE 199 04 265. However, none of these methods have been really successful on the market.

Another drawback of the wovens and knits is that the textured polyester yams employed are made of virgin PES chips, Consequently, the use of recycled material as a sustainable measure to save resources is not possible. In the future, there will also be cost disadvantages associated with the use of virgin PES material,

Furthermore, the processes of weaving and knitting as methods for producing a textile fabric are relatively wage-intensive.

In contrast, the production of a fusible interlining on the basis of a nonwoven is considerably more efficient and less wage-intensive. However, up until now, fusible interlinings with support layers made of nonwovens that are not made of yarns but rather of fibers were not considered for the above-mentioned use as a reinforcement fur the front sections of garments, especially sections of garments in the realm of menswear.

The support layers made of nonwovens are produced by means of the thermal calandering method (Point Seat=PS method) and are used primarily for small sections such as, for instance, edge and seam finishes, as waistbands, or fbr reinforcing collars and cuffs.

Another method for the production of fusible interlinings with support layers made of nonwovens is known, for example, from German patent application DE 10 2009 010 995 A1, European patent EP 2 207 926 B1 as well as international patent application WO 2009/059801 A1. In the case of the fusible interlinings described in these documents, the adhesive compound and the binder for bonding the nonwoven are applied in one work step. Here, a binder/polymer particle dispersion is applied onto a support layer on the basis of a weakly bonded nonwoven or fiber web. The polymer particles here constitute the adhesive compound. The dispersion is formulated in such a way that the polymer particles remain on the surface of the fiber web, whereas the binder penetrates into the surface of the fiber web. A heat treatment following the application of the dispersion serves to dry the fiber web, to crosslink the binder and to sinter the adhesive compound-polymer particles. According to these documents, the dispersion is preferably applied onto the support layer in a grid-like pattern of dots. The fusible interlinings manufactured as described above already stand out for their soft textile hand and their improved elasticity. Since they are based on a nonwoven support layer, they can be manufactured easily and inexpensively.

### SUMMARY

In an embodiment, the invention provides a fusible interlining usable as a front fusible interlining in the textile industry. The fusible interlining includes a support layer including a weakly bonded and water jet-structured fiber web or nonwoven. The support layer is bonded in preselected areas by a binder and has an adhesive compound on at least one side. The support layer has a grid-like hole structure.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a top view in a schematic depiction of a fusible interlining according to an embodiment of the invention, with perforations;

FIGS. 2, 3 shows a stress-strain curve diagram with the moduli of elasticity of a fusible interlining according to an embodiment of the invention and of an unstructured fusible interlining under lengthwise and crosswise extension;

FIGS. 4, 5 shows a stress-strain curve diagram with the moduli of elasticity of two fusible interlinings according to an embodiment of the invention with lengthwise/crosswise web formation and lengthwise web formation under lengthwise and crosswise extension; and

FIGS. 6, 7 shows a stress-strain curve diagram with the moduli of elasticity of two fusible interlinings according to an embodiment of the invention with lengthwise/crosswise web formation and lengthwise web formation under lengthwise and crosswise extension,

### DETAILED DESCRIPTION

In an embodiment, the invention provides a fusible interlining, which compared to the type described above, aside from its high volume and pleasant hand, also has improved elastic properties in terms of springiness and reversible elasticity, and moreover, can be manufactured easily and inexpensively,

According to an embodiment of the invention, a fusible interlining that can especially be used as a front fusible interlining in the textile industry has a support layer consisting of a weakly bonded and water jet-structured fiber web or nonwoven. The support layer is only bonded in select areas by means of a binder and it is provided with an adhesive compound on at least one side. According to an embodiment of the invention, the support layer is structured in such a way that it has a grid-like hole structure.

It has surprisingly been found that the grid-like hole structure in the support layer created by means of structuring with water jets, together with the bonding with a binder only over certain areas, give the fusible interlining a high reversible elasticity and a high springiness that actually fail in the ranges that are desirable for the front fusible interlining.

According to an embodiment of the invention, the support layer consists of a weakly bonded fiber web or nonwoven. This means that an embodiment of the invention should encompass all fiber fabrics whose fibers are still as movable as possible, even after undergoing bonding processes of varying intensities. This is the case, for example, with water jet-bonded nonwovens, even when high water pressures are used. These nonwovens are also to be covered by an embodiment of the invention.

“Structuring” or “water-jet structuring” as set forth in the invention refers to the rearrangement of fibers in a fabric by means of water jets in such a way that a grid-like dot pattern is created. However, in order to achieve the effect according to an embodiment of the invention, the holes do not have to be completely free of fibers.

According to a preferred embodiment of the invention, the hole structure is created by means of a water-jet method using a structuring screen. Water-jet processes are generally known for bonding, especially for pre-bonding, nonwovens. Typical water pressures for bonding or pre-bonding are about 150 bar or <50 bar. Water pressures in the range from 60 to 120 bar have proven to be advantageous for creating the hole structure in the fiber web or in the weakly bonded nonwoven according to an embodiment of the invention.

The water jets that act on the weakly bonded fiber web or nonwoven obviously press some of the fibers aside. As a result, a perforated structure having an unexpectedly high volume is formed in the support layer. At the same total weight, this volume of the fusible interlining is up to 0.40% higher than in the case of a woven or knit fabric of the same weight.

Especially preferably, the structuring (creation of the hole structure) is carried out within the scope of the pre-bonding of the fiber web or nonwoven. This ensures especially efficient processing.

The structuring of the fiber web calls for more energy and a higher water pressure than is the case, for example, with water-jet methods that are used only to achieve a pre-bonding of a fiber web, as described in German patent application DE 10 2009 010 995 A1. At the same time, however, the fiber web is more strongly pre-bonded. This has a positive effect on the abrasion resistance of the surface of the nonwoven.

Due to the pre-bonding that takes place simultaneously with the structuring, even if a perforation is present after the water-jet treatment, the fiber web itself is stable enough that it does not have to immediately undergo final bonding by means of printing. On the contrary, the patterned, three-dimensionally structured fiber web can be wound onto rollers when it is dry and, in a separate second work step, it can be coated and can undergo final bonding by means of any of the conventional coating methods. This means that a subsequent work step can be carried out for purposes of printing with a binder and applying adhesive compound polymers according to the 3-dot or double-dot coating method, which is particularly preferred for front fusible interlinings.

Advantageously, the pre-bonding and structuring of the fiber web by the water-jet method is carried out in such a way that first of all, the first side is sprayed with water jets through a first screen, for instance, a 100-mesh screen. As a result, a first pre-bonding of the fiber web is achieved, whereby the fiber web additionally acquires a uniform and smooth surface. Subsequent to the first pre-bonding, the opposite, second side of the pre-bonded fiber web is sprayed with water jets, for instance, through 20-mesh screen, in order to create the hole structure.

The mesh screens known from high-pressure energy (HE) water jet treatment can be used as the screens. These are screen drums in which the screen structure is created by a wire mesh. The thickness and cross section of the wires as well as the materials of the wires play a role in determining the volume achieved for the nonwoven because of the crimping that can be attained for the weave structure.

In order to manufacture the fusible interlinings according to an embodiment of the invention, the mesh screen is advantageously made of wires with a diameter ranging from 0.3 mm to 1.0 mm for the warp and from 0.2 mm to L5 mm for the weft. Round and rectangular wires made of stainless steel, bronze, PET or other plastics can be used.

By the same token, instead of mesh screens, it is also possible to use other screen structures or else perforated templates with a specific topography and water permeability for the structuring. The effects are similar to those achieved with a mesh screen.

A special hole geometry of the screens or templates can achieve desired effects. Without restricting the general scope of validity, the holes can be configured, for example, as rectangles or lozenges. In this context, the lengthwise/crosswise orientation of the rectangles results in a differing extensibility of the pre-bonded fiber web,

Crosswise rectangles result in a higher lengthwise extension than upright rectangles. Lozenges, in turn, are more uniform in terms of elongation.

The laying of the fibers in order to produce the fiber web or nonwoven is carried out in a generally known manner. The methods that can be used for this purpose are known and have been widely described in the patent literature. According to a preferred embodiment of the invention, the fibers (laying of the web) are laid in the lengthwise and crosswise directions. This yields a much greater elasticity of the final-bonded support material when they undergo mechanical elongation.

Especially preferably, the ratio of the square meter weight of the fibers laid lengthwise to that of the fibers laid crosswise is between 2:1 and 1:4, or else 100% are laid crosswise. Then it is ensured that a reversible lengthwise extensibility >20% can be achieved.

A multi-layer construction of the fiber web achieves additional effects in the finished material:
a) Higher weight fractions of the crosswise layer can reduce the reorientation of the fibers in the lengthwise direction.
b) The use of fibers with greater flexural stiffness in the crosswise layer (coarser PES (polyester) fibers and/or PA66 (polyamide 66) fibers) translates into improved crosswise springiness in the interlining
c) Bi-component fibers with thermal binding properties in the cover fiber web can be used for sealing, for deep-drawing the interlining.

Preferably, fibers made of polyester are an option as the fiber material. Special preference is given to fibers made of recycled PES (r-PET: recycled polyethylene terephthalate). Blends of recycled PES with other fibers are also possible. The blend ratio can be selected as desired. Consequently, the present invention also achieves the Objective of the sustainable use of raw materials.

Especially suitable fibers for the fusible interlinings according to an embodiment of the invention are fractions of fibers with a relatively high fiber titer up to 11 dtex. The use of coarser fibers further increases the totally atypical high springiness that is achieved according to an embodiment of the invention for the nonwovens.

According to an embodiment of the invention, the binder and/or the adhesive compound are not applied over the entire surface but rather only in selected areas of the surface on the support layer. This ensures the softness and springiness of the material. Preferably, the binder and/or the adhesive compound polymers are applied onto the support layer in a dot pattern. The dot pattern can be distributed regularly or irregularly. The punctually applied binder yields a considerably increased reversible inner strength of the structured nonwoven, while at the same time, maintaining a fraction of freely movable, unbonded fiber (areas) in the fiber bond. The binder dots also prevent an irreversible slipping of fibers in the structured nonwoven. This gives the structured nonwoven a high reversible elasticity. Thus, a very good reversible recovery after stretching is achieved within the extensibility range of 10% in the warp direction and 20% in the weft direction, which is needed for elastic fusible interlinings.

The present invention, however, is by no means limited to dot patterns. The mixture consisting of binder and thermoplastic polymer can be applied in any desired. geometry, for example, also in the shape of lines, stripes, net-like or grid-like structures, dots with rectangular, lozenge-like or oval geometries and the like.

Due to the superior volume and recovery capacity, the use of the structures nonwoven according to an embodiment of the invention can save 20% to 30% in terms of the material weight in comparison to a currently employed woven or knit fabric. Hence, a. perforated 60 g/m² nonwoven according to an embodiment of the invention replaces a 73 g/m² woven or knit fabric made of textured polyester yarns.

A special advantage of the present invention is that, by creating the hole structure, soft nonwoven support layers can be produced within a broad weight range between 15 g/m² and 115 g/m², without the nonwovens that have a high square meter weight becoming papery and stiff.

Since embodiments of the present invention is a fiber-based product, the hand problem encountered with woven and knit front fusible interlinings is solved since the fusible interlining according to an embodiment of the invention has fibers on the surface.

According to a preferred embodiment of the invention, the binder and adhesive compound are applied in one work step, as described, for instance, in German patent application DE 10 2009 010 995 A1, whereby in a generally known manner, a preferably aqueous dispersion consisting of a binder and a thermoplastic polymer in particle form is applied in a grid-like dot pattern onto the fiber web. The polymer particles here constitute the adhesive compound. The dispersion is formulated in such a way that the polymer particles remain on the surface of the fiber web, whereas the binder penetrates into the surface of the fiber web. A heat treatment that follows the application of the dispersion serves to dry the fiber web, to crosslink the binder and to sinter the adhesive compound-polymer particles.

The type of dryer used for drying the described interlining materials is important. Belt dryers that use air-through technology are preferred over cylinder dryers and suction-through drum dryers since the latter lead to flat products. The highest possible dryer temperatures 190° C. [374′FD result in the stabilization of the volume and in the thermofusion of the finished material.

For applications in which higher delamination forces are needed, for example, in case of use as a front fusible interlining, the adhesive compound is applied by means of a generally known double-dot coating method. The double-dot coating method involves a first process step in which the bottom dot, which usually consists of a binder and serves as a soak-through barrier, is applied onto the fiber web and then, in a second process step, the top dot that forms the actual adhesive compound is applied onto the bottom dot.

In order to enhance the punctual bonding of the nonwoven that has been provided with a hole structure and in order to increase the abrasion on the side facing away from the adhesive compound, a larger quantity can be applied onto the bottom dot than is normally needed for the usual double-dot coating. If the applied quantity of binder is sufficient to ensure that it penetrates at least partially through the fiber web or the weakly bonded nonwoven, then the punctual bonding of the support layer can be achieved exclusively by means of the bottom dot. Another application of binder is not necessary. For this purpose, the penetration depth of the binder perpendicular to the surface should be more than 30%, especially preferably more than 40%, and very particularly preferably more than 70%, so that an adequate reversible elasticity and springiness are ensured.

The fusible interlining according to an embodiment of the invention is especially well-suited for use as a front fusible interlining in the textile industry, especially in the realm of upper-end garments such as, for example, men's clothing.

### EXAMPLES

### Embodiment 1 (PDB_{—}3 cc47)

A fiber web consisting of 30 g/m² of PES 1.7 dtex/38 mm (r-PET: recycled PES) fibers, laid in the form of a 10 g/m² lengthwise web and a 20 g/m² crosswise web was fed into a preliminary crosslinking unit. Here, a slight pre-bonding was carried out with low-pressure water jets (<50 bar) using a 100-mesh screen. A. 20-mesh bronze screen (warp wire diameter: 0.63 mm×0.33 mm//weft wire diameter: 0.51 mm//mesh×count [cm]: 9.5/8.5//thickness: 1.09 mm) was installed on a second drum of the preliminary crosslinking unit. The structuring was carried out with medium-pressure water jets (<80 bar). The wet fiber web was then printed in-line in a dot pattern (52 dots per cm²) with 15 g/m² (dry) of a binder polymer particle dispersion consisting of
9 parts of self-crosslinking butyl acrylate/ethyl acrylate binder dispersion at a tg=−28° C. [−18.4° F.]
24 parts of co-polyamide powder 60μ to 130μ with melting range around 115° C. [239° F.]
1 part of wetting agent a//n/i
2 parts of thickener
59 parts of water.

During the subsequent drying step, the binder dots were crosslinked with the fibers and the polymer particles were sintered.

The fusible interlining obtained according to an embodiment of the invention had the following properties:
square meter weight: 45 g/m²
lengthwise/crosswise modulus: 6.9 N at 10% lengthwise extension and 1.5 N at 20% crosswise extension.
recovery: permanent set after 15 cycles: 3.1% lengthwise at 10% and 5.8% crosswise at 20%.
resilience comparable to a 60 g/m² woven fabric interlining with textured filaments having a dtex of 75 f48 in the warp and the well.
the achieved delamination force, after fusing to a PES/cotton fabric at 2.5 bar and 12 seconds was
   at 120° C. [248° F.] primarily: 15.6 N/5 cm//12.6 N/5 cm washed at 40° C. [104° F.]//11.9 N/5 cm CR,
   at 140° C. [284° F.] primarily: 17.3 N/5 cm//13.8 N/5 cm washed at 40° C. [104° F.]//10.6 N/5 cm washed at 60° C. [140° F.].

### Embodiment 2

A fiber web laid in the form of 10 g/m² lengthwise web consisting of 100% PES 1.7 dtex/38 mm (r-PET) fibers and 15 g/m² crosswise web consisting of 50% PES 1.7 dtex/38 mm (r-PET), 30% PES 3.3 dtex/60 mm (r-PET) and 20% PES 6.7 dtex/60 mm was fed into a preliminary crosslinking unit. Here, a slight pre-bonding was carried out with low-pressure water jets at (<50 bar) using a 100-mesh screen. A 20-mesh bronze screen (warp wire diameter: 0.63 mm×0.33 mm//weft wire diameter: 0.51 mm 1//mesh×count [cm]: 9.5/8.5//thickness: 1.09 mm) was installed on a second drum of the preliminary crosslinking unit. The structuring was carried out with medium-pressure water jets (<80 bar). The wet fiber web was dried and pre-fused at 180° C. [356° F.] in a 3-belt dryer with an air-through flow pattern. This slightly bonded 20-mesh structured nonwoven was then moistened with water in a second work step in a foulard—100% wet pickup—and then printed in a dot pattern (72 dots per cm²) with 14 g/m² (dry weight) of a binder-polymer particle dispersion.

In the subsequent drying step, the binder dots were crosslinked with the fibers and the polymer particles were sintered.

The fusible interlining obtained had the following properties:
weight: 39 g/m²
lengthwise/crosswise modulus: 5.8 N at 10% lengthwise extension and 1.9 N at 20% crosswise extension.
recovery: permanent set after 15 cycles: 2.9% lengthwise at 10% and 4.9% crosswise at 20%.
resilience comparable to a 60 g/m² woven fabric interlining with textured filaments having a dtex of 75 f48 in the warp and the weft, whereby the resilience was higher in the crosswise direction.
the achieved delamination three, after fusing to a PES/cotton fabric at 2.5 bar and 12 seconds was
   at 120° C. [248° F.] primarily: 13.3 N/5 cm//11.9 N/5 cm washed at 40° C. [104° F.]//11.6 N/5 cm CR,
at 140° C. [284° F.] primarily: 15.7 N/5 cm//13.6 N/5 cm washed at 40° C. [104° F.]//11.2 N/5 cm washed at 60° C. [140° F.].

### Embodiment 3

A 20-mesh structured water jet-bonded nonwoven 35 g/m² consisting of 100% 1.9 dtex PES fibers was printed in a 2-step process with 9 g/m² dispersion consisting of printing paste components analogous to European patent EP 1 162 304 B1, and subsequently 13 g/m² of adhesive compound polymer with a grain size distribution of 80 p. to 200 p. was applied. In the subsequent drying step, the two-layered adhesive compound application was sintered in the dryer.

The fusible interlining obtained had the following properties:
weight: 57 g/m²
lengthwise/crosswise modulus: 9.7 N at 10% lengthwise extension and 3.1 N at 20% crosswise extension.
recovery: permanent set after 15 cycles: 3.6% lengthwise at 10% and 5.6% crosswise at 20%.
resilience comparable to a 70 g/m² woven fabric interlining with textured filaments having a dtex of 75 f48 in the warp and the weft.
the achieved delamination force, after fusing to a PES/cotton fabric at 2.5 bar and 12 seconds was
at 120° C. [248° F.] primarily: 17.4 N/5 cm//17,0 N/5 cm washed at 40° C. [104° F.]//CR 16.2 N/5 cm,
at 140° C. [284° F.] primarily: 17.7 N/5 cm//20.9 N/5 cm washed at 40° C. [104° F.]//17.4 N/5 cm washed at 60° C. [140° F.].

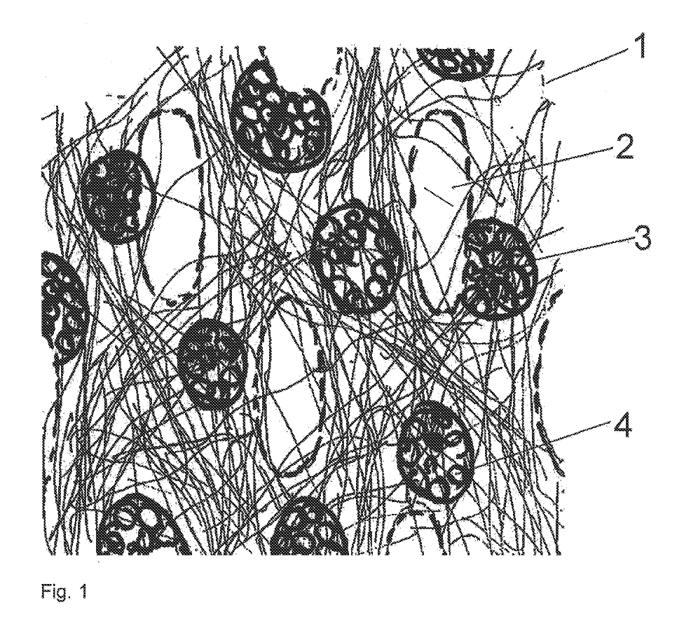

In FIG. 1, one can see a fiber web 1 consisting of fibers laid lengthwise and crosswise. According to an embodiment of the invention, the fiber web 1 has a hole structure. The holes 2 in the fiber web 1 are arranged in the form of a grid. In the figure, one can also see bonding dots 3 arranged in an irregular dot pattern that bond the fiber web 1 in selected areas of the surface and, at the same time, carry the adhesive compound particles 4. In the areas of the surface situated between the bonding dots 3, the fibers are freely movable. This effect is further intensified by the hole structure. The material is highly elastic.

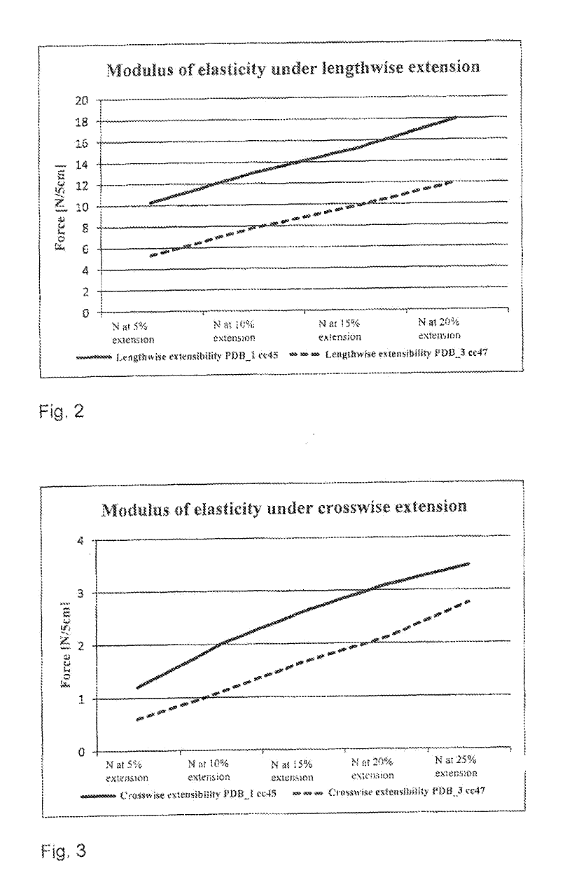

FIGS. 2 and 3 show how the structuring of a fusible interlining according to the invention as described in Embodiment 1 and an unstructured comparative fusible interlining cc45), which was made with a 100-mesh screen in the second HE passage but otherwise made in the same manner, influence the stress-strain behavior. It can be seen that the unstructured nonwoven can be stretched lengthwise and crosswise under much higher forces than the structured nonwoven. The extensibility is promoted by the structuring, the fraction of the elastic extension is increased in the case of the fusible interlining according to an embodiment of the invention.

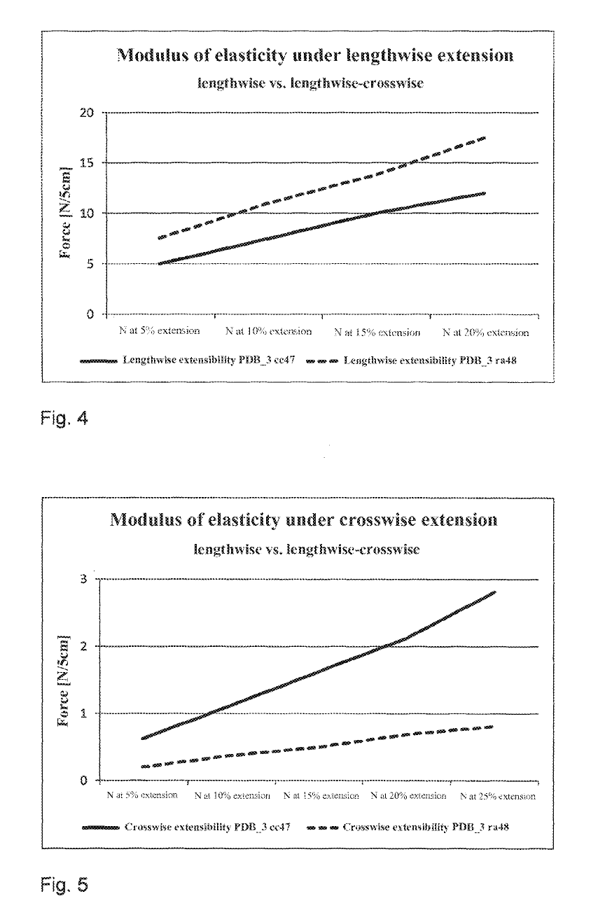

FIGS. 4 and 5 shows how the laying of the nonwoven of the fusible interlining of Embodiment 1 and of a comparative fusible interlining (PDB ra48), which was laid only lengthwise but otherwise made in the same manner, influence the stress-strain behavior. One can see that the lengthwise oriented and structured nonwoven can be stretched lengthwise under much higher forces than the lengthwise/crosswise oriented and structured nonwoven according to Embodiment 1. The extensibility is promoted by the lengthwise/crosswise laying of the fibers. It can also be seen that the lengthwise oriented and structured nonwoven has an extremely slight extensibility in the crosswise direction in contrast to the fusible interlining according to Embodiment 1 with the lengthwise/crosswise laying of the nonwoven. However, this slight extensibility does not provide any forces for the recovery and is thus undesired.

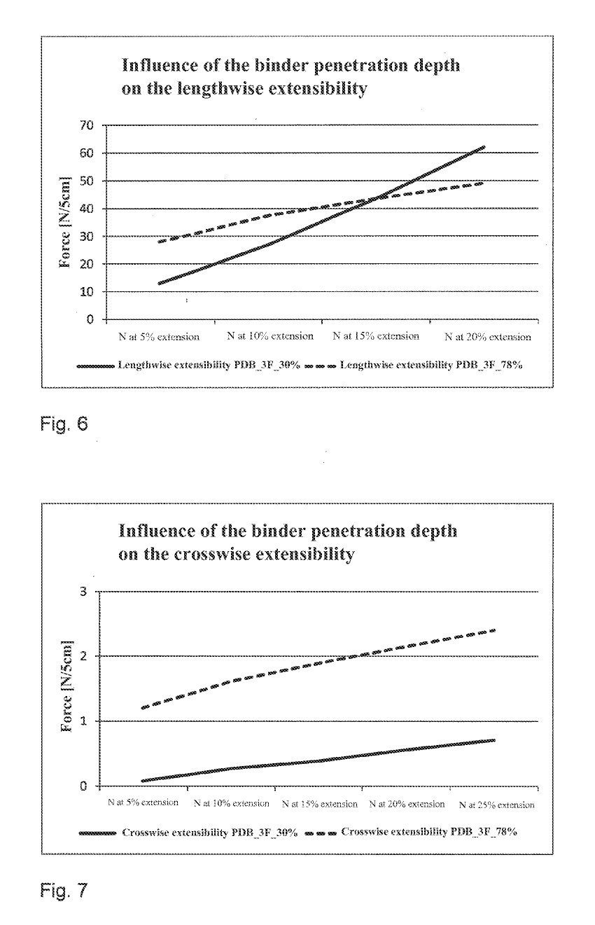

FIGS. 6 and 7 show how the penetration depth of the binder into the support layer influences the stress-strain behavior of two fusible interlinings according to embodiments of the invention. The maximum tensile forces at a penetration depth of 30% and 78% perpendicular to the surface are shown.

In the case of the 3-dot or double-dot coating method, it is desirable for the bottom dot layer not to sink too deeply into the fiber web during the printing since this is associated with a hardening of the hand. At the same time, however, the strength of the nonwoven declines when the through-bond brought about by the printed binder is weak.

A lower strength/maximum tensile force reduces the reversibility of the elastic elongation of the structured nonwoven.

It can be seen in the figures that, when stretched slightly, the nonwoven bonded at a penetration depth of 30% has less lengthwise strength than the fusible interlining that is more strongly through-bonded at a 78% penetration depth of 78%. When the fiber web is less through-bonded, the fibers “slip” off each other more easily. This effect is even more visible in the case of crosswise stretching. There are hardly any reversible recovery forces in the fusible interlining that was bonded at a penetration depth of 30%. Consequently, a through-bonding of more than 30% is preferred.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

What is claimed is:

1. A fusible interlining usable as a front fusible interlining in the textile industry, the fusible interlining comprising a support layer including a weakly bonded and water jet-structured fiber web or nonwoven, the support layer being bonded in preselected areas by a binder and having an adhesive compound on at least one side, wherein the support layer has a grid-like hole structure.

2. The fusible interlining according to claim 1, wherein the hole structure is formed by a water-jet method using at least one of a structuring screen and a template.

3. The fusible interlining according to claim 2, wherein at least one of the binder and the adhesive compound is disposed in a grid-like regular or irregular dot pattern.

4. The fusible interlining according to claim 1, wherein the support layer includes the fiber web, the fiber web being configured with a plurality of layers having at least one layer laid lengthwise and at least one layer laid crosswise.

5. The fusible interlining according to claim 1, wherein the adhesive compound is disposed as adhesive compound dots in a grid-like regular or irregular dot pattern, the adhesive compound dots each being configured as double dots with a bottom dot and a top dot, wherein the bottom dots consist of a binder and the top points consist of a thermoplastic polymer.

6. The fusible interlining according to claim 1, wherein the adhesive compound is disposed as adhesive compound dots in a grid-like regular or irregular dot pattern, the adhesive compound dots each being configured as double dots with a bottom dot and a top dot formed using a double-dot method having at least two stages, in which a binder is first applied onto the support layer in a first step, and then a thermoplastic polymer is applied onto the binder in a second step.

7. The fusible interlining according to claim 1, wherein the adhesive compound is disposed as adhesive compound dots in a grid-like regular or irregular dot pattern, the adhesive compound dots each being configured as double dots with a bottom dot and a top dot formed in one step by applying a binder-polymer particle dispersion onto the fiber web in such a way that a binder penetrates at least partially into the fiber web and forms the bottom dots, while particles made of thermoplastic polymer remain on the surface of the fiber web and form the top dots.

8. The fusible interlining according to claim 7, wherein the binder for the bottom dots present in the binder-polymer particle dispersion in such an amount that the bonding of the fiber web or the nonwoven is provided exclusively by the bottom dots without any further addition of binder.

9. The fusible interlining according to claim 1, wherein the support layer consists essentially of fibers of recycled polyethylene terephthalate.

10. The fusible interlining according to claims 1 to 9, wherein the square meter weight of the support layer ranges from 15 g/m² to 120 g/m².

11. A method of using a fusible interlining in the textile industry, comprising:
providing the fusible interlining comprising a support layer including a weakly bonded and water jet-structured fiber web or nonwoven, the support layer being bonded in preselected areas by a binder and having an adhesive compound on at least one side, wherein the support layer has a grid-like hole structure; and
using the fusible interlining as a front fusible interlining in menswear textiles.
